(19) United States
(12) Patent Application Publication
(10) Pub. No.: US 2007/0171075 A1
(43) Pub. Date: Jul. 26, 2007

(54) Eyelet for a radio frequency identification

(76) Inventor: Jae Hyung Ryu, Seoul (KR)

Correspondence Address: LADAS & PARRY LLP, 224 SOUTH MICHIGAN AVENUE, SUITE 1600, CHICAGO, IL, 60604, US

(21) Appl. No.: 10/590,990

(22) PCT Filed: Mar. 18, 2005
(86) PCT No.: PCT/KR05/00780

§ 371 Date: Aug. 29, 2006

(30) Foreign Application Priority Data
Mar. 22, 2004 (KR) 10-2004-0019200

(51) Int. Cl. G08B 13/14

(52) U.S. Cl. 340/572.8

(57) ABSTRACT

Provided is an RED eyelet performing non-contact identification function. The RFID eyelet includes an eyelet washer and eyelet base composed of nonconductive material, and an RED module is interposed between the eyelet washer and eyelet base. The RFID eyelet contains the RFID module in nonconductive material, thereby performing smooth electromagnetic wave communication without disturbance, and the eyelet base is simply coupled. with the eyelet washer by using a slanted projection formed in the eyelet base and a locker formed in the eyelet washer. Also, the RED module can be easily installed by using an internal flange or external flange formed in the inside of the eyelet base or eyelet washer, thereby having a merit of mass production.

### TECHNICAL FIELD

The present invention relates to a tag using Radio Frequency Identification (RFID) technology, and more particularly, to a tag for RFID, which can be applied regardless of the sort and form of an object requiring identification and be used for multiuse.

### BACKGROUND ART

An RFID tag generally composed of an antenna and an IC chip transmits and receives predetermined data from an external reading unit. The RFID tag is called as a transponder. The RFID tag can transmit and receive required data from an external reader-writer device according to a non-contact method. For example, the RFID tag is used in managing products because of the characteristic of the non-contact method and is variously used for IC cards for payment or passes. The RFID tag can transmit and receive data with a reader-writer device by using the non-contact method. According to some method, since the RFID tag generates a electric power by itself with receiving high frequency from a reader-writer device and resonating an induced current, the RFID tag can be operated without a battery.

TABLE 1

| Category | Method | Application | Advantages | Disadvantages |
|---|---|---|---|---|
| Use a tag as it | Insert a tag | Parcels or | Simplicity, | Loss, worry about |
| is | in a packaging | clothes | reducing the cost | changing, |
| | or product | | for coupling, easy | unfavorable for |
| | | | recycling | harsh environment |
| Lamination | Laminate and | All sorts of | Favorable for | Not good for |
| | wrap a tag to | cards | carrying | coupling, high cost |
| | into a card | | | |
| Sticker | Apply an | Replace | Most general, | Unfavorable for a |
| (Adhesive) | adhesive to a | barcodes | familiar to | condition requiring |
| | tag to be | | conventional | coupling and |
| | changed into | | barcode stickers | recycling |
| | a sticker | | | |
| Molding | Molding the | Tires, | Most favorable | Unfavorable for |
| | outer surface | casinos, chips | for an inferior | recycling and |
| | of a tag | | condition | difficult to process |

As illustrated in Table 1, there are many methods for providing an RFID tag, such as using a tag as it is, producing a card-type tag using laminating, using an adhesive as a sticker, molding a tag by injection molding, etc. However, a method of using a tag for parcels or clothes has advantages in which coupling is simple and recycling is possible and disadvantages in which a risk of loss exists and a tag can be easily damaged by an external shock. Also, a tag manufactured by molding has an advantage of protecting an inner RFID module in order to be used in an inferior condition but has disadvantages in which the tag manufactured by molding can not be recycled because RFID components cannot be separated to bee used in other usages and injection molding itself costs relatively higher and more difficult than other processes.

As described above, the RFID tag is composed of an antenna and an IC chip. Basically, a substrate formed in a sheet shape composed of a plastic material such as PVC, PCB, PE, and PA, and the substrate is formed to a thickness of approximately less than 100 μm to form the antenna. A wire section of the antenna is installed above the substrate with a chip or connected to a chip outside of a film by using a direct bonding method or a chip on board (COB) method.

Generally, the size of the RFID tag may be determined according to the size of chips, the size of antennas, proficiency in a process, and use of a battery for generating electric power, etc. Currently, since the technical level with respect to a chip size and the proficiency becomes notably high, the size of the RFID tag is determined depending on the size of antennas. Accordingly, the size of antennas is determined depending on recognition range required in a reader-writer device, and the size of tags can be enlarged or reduced according to the determined antenna size. In addition, the size of antennas can be determined according to the range of used frequency. Since frequency recently employed in conventional RFID is in a band from approximately 13.56 MHz and under, there is a limitation in the size of antennas and the material of housings. However, it will be tried to use communication frequency for RFID from approximately 900 MHz and over, thereby relaxing the limitation on the antenna size and housing material. Since a tag for RFID used in a high frequency band more than approximately 900 MHz can more smoothly perform electromagnetic wave communication with a reader-writer device than a tag for RFID used in low frequency band, the antenna size and component material are less limited. Accordingly, it is expected that the size of RFID tags can be substantially reduced and RFID tags in various forms in which shapes and sizes are not limited can be realized.

However, regardless of the antenna size and frequency band, conductive materials disturb smooth communication between RFID tags and a reader-writer device. For example, in case that an RFID tag is attached to a metal surface or is covered by metal to protect, eddy current occurs in the metal caused by alternating current magnetic field generated by electromagnetic waves. The eddy current generates magnetic flux bounding against magnetic flux for transmission and receipt to attenuate the magnetic flux for transmission and receipt, thereby disturbing smooth communication. Particularly, conventionally used frequency that is approximately 13.56 MHz or less corresponds to relatively low frequency, and there are many problems generated by communication failure caused by peripheral conductive material in using RFID tags in the frequency band.

### DISCLOSURE OF INVENTION

Technical Goals

To solve the problems described above, a housing formed of nonconductive material such as plastic may be used for protecting an RFID module and smooth communication between the RFID module and a reader-writer device. However, the durability of the nonconductive material such as plastic is poor against external shocks. A container firstly protecting an RFID module may be formed by using the nonconductive material but breakage caused by an impact cannot be avoided by using the structure of a conventional RFID tag.

The present invention provides an RFID tag which can firstly insulate an RFID module from the outside and simultaneously not disturb smooth communication between the RFID module and a reader-writer device and secondly protect the RFID module The present invention provides an RFID tag that can be minimized, simply installed, simply separated, and recycled to be economical.

The present invention provides an RFID tag its structure can present various shapes and colors and be availably used in addition to being used as a tag.

Technical Solutions

To achieve the goals of the present invention described above, according to a preferable embodiment of the present invention, there is provided an eyelet for RFID (hereinafter, referred to as an RFID eyelet for convenience of description) including an eyelet washer, an eyelet base, and an RFID module. Basically, in constructing an RFID tag, the structure of an eyelet is used. The RFID module is interposed between the eyelet base and the eyelet washer with an object. The eyelet base or eyelet washer formed with the same size as the RFID module or larger than the RFID protect the RFID module by insulating from the outside and effectively protect the RFID module from external shocks by using the structure of the eyelet that is adhere to the object and firmly fixed to the object.

Also, such that the RFID module can easily communicate with an external reader-writer device in a low frequency band from approximately 13.56 MHz and under, the eyelet washer and eyelet base may be composed of nonconductive material. In case that conductive material is used, an RFID module installed in the same has a difficulty in communication with the reader-writer device. The electromagnetic wave communication between the RFID module and the reader-writer device can be performed without any disturbance by using nonconductive material. Also, if fragile nonconductive material is used, the eyelet structure that is adhered to the object to be fixed and has a relatively small size is used, thereby effectively protecting the RFID module from harsh external environment. In addition, since the eyelet is widely used in really many fields in real life, the application field and ripple effects can be enormously grown. Since the process of manufacturing and equipping the eyelet is also simple and there are already many manufacturing facility systems, the cost of the RFID tag can be notably lowered.

For example, currently eyelets are used in tags used for identifying goods sent by air freight or rail freight. In this case, if eyelets for RFID replace conventional ordinary eyelets, information on goods can be automatically grasped instead of confirming one by one and the lost articles or wrong delivery can be prevented. Also, the RFID eyelet can endure external shocks or other harsh environments and protect the RFID module inside the RFID eyelet. In case that the RFID tag is engaged with a package by a wire or a rubber band, the tag can be separated to be recycled, that is very economical.

In addition, the RFID eyelet can be simply fixed to various objects by using conventional eyelet interlock units, and non-contact method identification technology using RFID via the RFID eyelet can be applied to various fields, not only fields in which eyelets are used, such as clothes, shoes, lightproof tents, tents for construction materials, but also some fields in which eyelets are not used.

In the present specification, the meaning of an eyelet or grommet includes not only an eyelet as a simple fastener but also forming a relatively strengthened hole on weak material such as paper and textile. Accordingly, various elements in the shape of a conventional eyelet may be applied to the eyelet of the present invention.

An eyelet is generally composed of an eyelet base corresponding to a male part and an eyelet washer corresponding to a female part. The eyelet washer is disposed against the eyelet base, adhered and fixed to the eyelet base with an object is therebetween. The eyelet washer is fixed to the object by a barrel of the eyelet base and supports a hole formed in the object via the barrel or a hole formed in the eyelet washer.

In the present invention, the shape or sort of the eyelet can be known with reference to conventional eyelets. That is, the external form of the eyelet can be variously changed according to the shape of a rim or the eyelet washer, such as the shape of circle, oval, and square. Particularly, the eyelet washer is formed larger than the eye base to use the eyelet washer itself as a tag. In this case, required information can be recorded in the eyelet washer.

It is one of great advantages that conventional eyelet coupling devices can be used for equipping an object with the eyelet. A device that can automatically or manually feed the RFID module to a conventional eyelet coupling device can be additionally used. The RFID module is simply adhered to an object and can be engaged with the object by using a conventional eyelet coupling device to connect the RFID eyelet. That is, since a conventional coupling device can be used, there is no heavy load to add the RFID technology to the eyelet.

In the RFID eyelet, the eyelet washer and eyelet base can be composed of nonconductive material such as plastic. Only, while conventional eyelet washer and eyelet base composed of a metal with high malleability and ductility can be processed via pressing, an eyelet washer and eyelet base composed of plastic can not be processed via pressing by using malleability and ductility. To solve the problem, at least one slanted projection is formed on the outer surface of a barrel in the eyelet base, and a locker is formed in the eyelet washer in response to the slanted projection. One or a plurality of slanted projections can be formed according to purpose and use condition, and one or a plurality of lockers can be formed in response to the projection. In case that a plurality of slanted projections or lockers are formed, the eyelet base and eyelet washer can be fixed to an object maintaining various intervals according to the thickness of the object.

Also, an internal flange or external flange projected toward inside can be formed on the inner circumference or outer circumference of the eyelet washer. The internal or external flange protects the RFID module and simultaneously fixes the RFID module in the RFID eyelet. For example, a designer can control the diameter such that a passage hole of the RFID module is circumscribed about the internal flange. In this case, even if the outer diameter of the RFID module is changed, the RFID module can be stably fixed on the basis of the internal flange. Also, a designer can control the outer diameter of the RFID module such that the RFID module is inscribed in the external flange. The size of a coil antenna can be changed according to the use of the RFID eyelet. In this case, the size of an RFID substrate is controlled based on the internal or external flange to simply assemble and stably fix the RFID module. Of course, in case that the RFID module is interposed between the object and the eyelet base, the eyelet base including the external flange can assist in assembling and fixing the RFID module.

### BRIEF DESCRIPTION OF DRAWINGS

FIG. 1 is an exploded perspective view of an RFID eyelet according to a first embodiment of the present invention;

FIG. 2 is a partial cross-sectional view illustrating a state of engaging the RFID eyelet according to the first embodiment;

FIG. 3 is a schematic diagram illustrating a state of using the RFID eyelet 100 according to the first embodiment;

FIG. 4 is an exploded perspective view illustrating an RFID eyelet according to another embodiment of the present invention, which is similar to the first embodiment;

FIG. 5 is an exploded side view of an RFID eyelet according to a second embodiment of the present invention;

FIG. 6 is a partial cross-sectional view illustrating a state of engaging the RFID eyelet according to the second embodiment;

FIG. 7 is an exploded side view of an RFID eyelet according to a third embodiment of the present invention; and

FIG. 8 is a bottom view illustrating a state of engaging the RFID eyelet according to the third embodiment.

### BEST MODE FOR CARRYING OUT THE INVENTION

Hereinafter, preferable embodiments of the present invention will be described in detail with reference to the attached drawings. However, the present invention should not be construed as being limited to the embodiments set forth herein.

### Embodiment 1

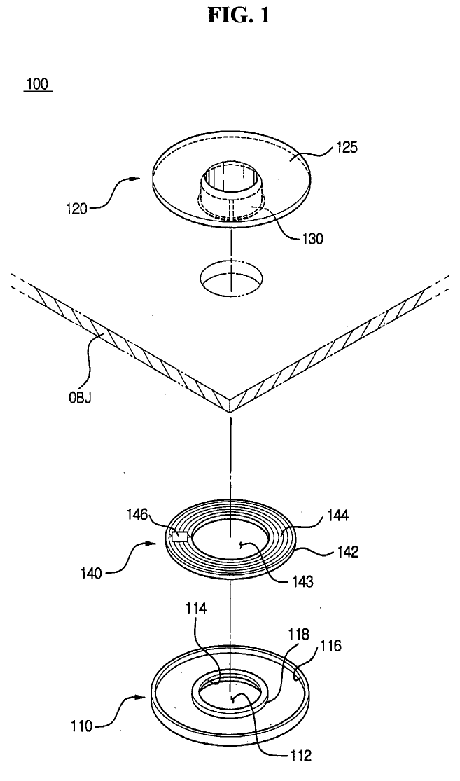

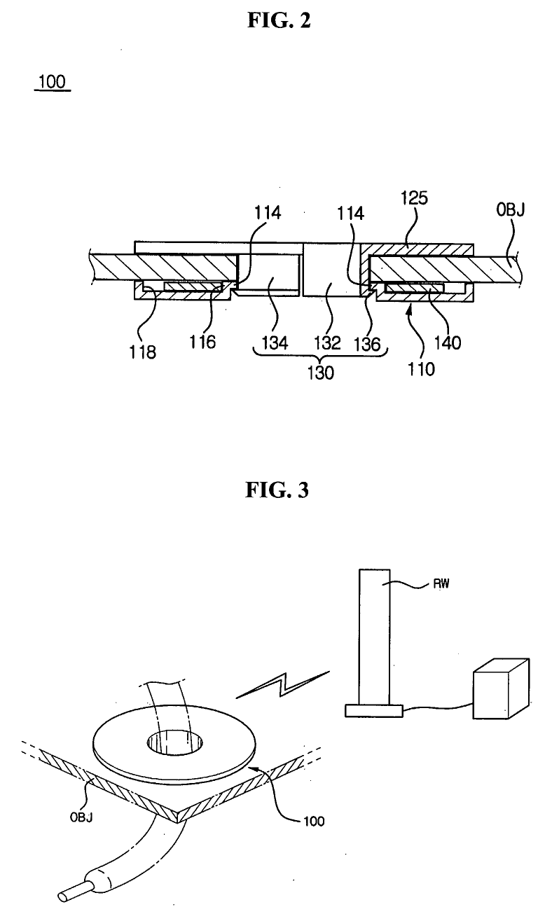

FIG. 1 is an exploded perspective view of an RFID eyelet according to a first embodiment of the present invention, and FIG. 2 is a partial cross-sectional view illustrating a state of engaging the RFID eyelet according to the first embodiment.

Referring to FIGS. 1 and 2, an RFID eyelet 100 according to the first embodiment includes an eyelet washer 110, an eyelet base 120, and an RFID module 140. An object OBJ and the RFID module 140 are interposed between the eyelet washer 110 and eyelet base 120 and adhered and fixed by interlock of the eyelet washer 110 and eyelet base 120.

The eyelet washer 110 is formed in a shape of a ring, and a washer hole 112 is formed in the center of the eyelet washer 110. A locker 114 is formed peripherally on the inside of the washer hole 112. Also, on the top side of the eyelet washer 110, where faces the object OBJ, an external flange 116 and internal flange 118 are formed around the outer circumference and inner circumference of the eyelet washer 110, respectively. The RFID module formed in a shape of a ring is disposed in a space provided between the external flange 116 and internal flange 118. The eyelet washer 110 is adhered and fixed to the object OBJ such that the RFID module 140 can be insulated from the outside by the eyelet washer 110 and protected from external shocks.

The eyelet base 120 is provided being faced with the eyelet washer 110. The eyelet base 120 includes a rim 125 and a barrel 130 formed in a single body with the rim 125. The barrel 130 includes a first barrel piece 132 and second barrel piece 134 to form a cylinder shape. In this case, the end portions of the first barrel piece 132 and second barrel piece 134 are coupled to an inner hole of the rim 125 as a single body to elastically support the first barrel piece 132 and second barrel piece 134. A slanted projection 136 is formed on the end portion of the first barrel piece 132 and second barrel piece 134 in response to the locker 114. The slanted projection 136 is formed on the end portion of first barrel piece 132 and second barrel piece 134 to form a ring shape and passes the washer hole 112 of the eyelet washer 110 to interlocked with the locker 114. In this case, the first barrel piece 132 and second barrel piece 134 pass through the washer hole 112 and elastically return to an original state to maintain engagement between the slanted projection 136 and locker 114.

The RFID module 140 is formed in a ring shape similar to the eyelet washer 110. The RFID module 140 includes an RFID substrate 142 including a passage hole 143 in response to the barrel 130, an antenna 144 formed around the passage hole 143 on the RFID substrate 142, and an RFID chip 146 electrically connected to the antenna 144. The RFID substrate 142 is composed of nonconductive material such as PVC, PCB, PE, and PA in a shape of a thin sheet formed to a thickness from approximately 100 μm and under. The antenna 144 is formed on the RFID substrate 142. The meaning of a coil of the antenna 144 is a shape of a spiral on a flat surface and includes a shape formed in various types such as a square and oval in addition to a circle. In the present embodiment, the antenna 144 is formed spiraling around the passage hole 143. Generally, a cupper thin film or aluminum thin film is formed on the RFID substrate 142, and the thin film is partially removed according to antenna pattern by an etching method, thereby forming the antenna 144. Of course, a wire section of the antenna 144 may be formed by embedding method.

After the RFID chip 146 is installed above the RFID substrate 142, the wire section of the antenna 144 is electrically connected to the RFID chip 146, thereby completing the RFID module 140. In order to electrically connect the antenna 144 to the RFID chip 146, many coupling methods can be used, such as direct bonding, soldering by a COB method, ultrasonic wave welding, spot welding, and adhesion by using a conductive bond.

Since the eyelet washer 110 and eyelet base 120 for protecting the RFID module 140 are composed of nonconductive material, the electromagnetic wave communication between the RFID module 140 and an external reader-writer device RW can be performed without disturbance. Also, the size of the passage hole can be controlled such that the internal flange 118 of the eyelet washer 110 circumscribes the passage hole 143 of the RFID substrate 142. The shape of the RFID substrate 142 is controlled based on internal flange 118 or external flange 116, thereby rapidly installing the RFID module 140 to the eyelet washer 110, stably fixing the RFID module 140 after assembling, and preventing the RFID module 140 from being out of the regular position. In the present embodiment, the diameter of the passage hole 143 of the RFID module 142 is controlled to be the same as the outer diameter of the internal flange 118 to circumscribe the internal flange 118. According to another embodiment of the present invention, the outer diameter of the RFID substrate 142 can be controlled to be inscribed in the external flange 116. The size of the RFID substrate 142 of the RFID module 140 can be controlled according to the size of the antenna 144. The more increased the size of the antenna 144 is, the more lengthened the width of the RFID substrate 142 and the wider the region of the recognition with respect to the reader-writer device RW.

Referring to FIG. 1, the RFID module 140, the object OBJ, and the eyelet base 120 are sequentially installed above the eyelet washer 110. An eyelet coupling device (not shown) can couple the eyelet after the component of the RFID eyelet 100 is arranged according to the sequence.

FIG. 3 is a schematic diagram illustrating a state of using the RFID eyelet 100 according to the first embodiment.

Referring to FIG. 3, the RFID eyelet 100 closely passes the reader-writer device RW and receives a signal with respect to data requirement from the reader-writer device RW, and the RFID chip 146 can generate a signal in response to the signal received from the antenna 144 and modify stored data inside. In this case, the RFID module 140 is protected by the eyelet washer 110 and eyelet base 120 composed of nonconductive material and can perform electromagnetic communication without disturbance.

The object OBJ may be a tag which is engaged with a package to indicate the destination and starting position of the package, or may be a tag which is used for all sorts of mails, packages, wraps, clothes, tents for freight cars, managing animals.

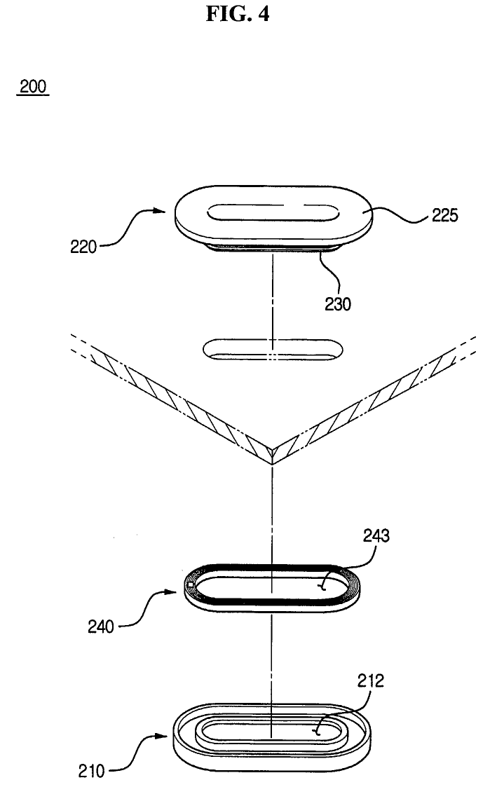

FIG. 4 is an exploded perspective view illustrating an RFID eyelet according to another embodiment of the present invention, similar to the first embodiment.

Referring to FIG. 4, an RFID eyelet 200 includes an eyelet washer 210, an eyelet base 220, and an RFID module 240. The eyelet base 220 includes not only a rim 225 but also a barrel 230 composed of first and second barrel pieces. The RFID eyelet 200 of FIG. 4 is formed in a shape of an oval. According to the RFID eyelet 200, not only the eyelet washer 210, the eyelet base 220, and the RFID module 240 but also the barrel 230, a passage hole 243, and a washer hole 212 are formed in an oval shape. There is a little difference in the shape, and main components and functions are actually as the same as the RFID eyelet 100 of the first embodiment. The description and drawings of the first embodiment can be referred with respect to the main components and functions.

That is, the RFID eyelet can be formed in various shapes, and the eyelet can be variously selected to be changed according to requirements or tendency of users. Examples of using an eyelet as a fastener can be applied to the present invention.

### Embodiment 2

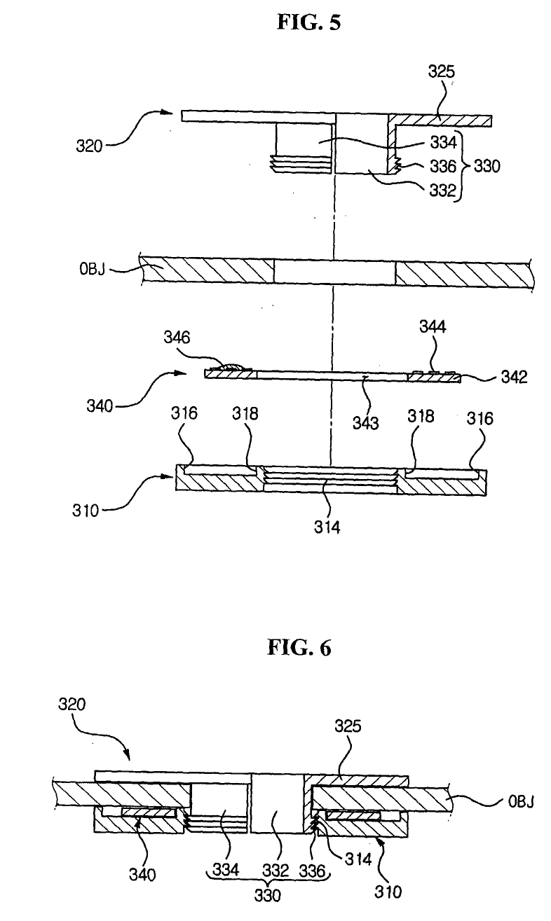

FIG. 5 is an exploded side view of an RFID eyelet according to a second embodiment of the present invention, and FIG. 6 is a partial cross-sectional view illustrating a state of coupling the RFID eyelet according to the second embodiment.

Referring to FIGS. 5 and 6, the RFID eyelet according to the second embodiment includes an eyelet washer 310, an eyelet base 320, and an RFID module 340. An object OBJ and the RFID module 340 are interposed between the eyelet washer 310 and the eyelet base 320 and adhered and fixed by interlock of the eyelet washer 310 and eyelet base 320.

As the same as the first embodiment, the eyelet washer 310 is formed in a shape of a circle, and a washer hole 312 and a locker 314 are formed in the center of the eyelet washer 310. A plurality of projections of the locker 314 are formed to be faced with the eyelet base 320 as a slanted projection 336 of the eyelet base 320.

An external flange 316 and internal flange 318 are formed around the outer circumference and inner circumference of the eyelet washer 310, respectively, in the inside of the eyelet washer 310. The RFID module 340 formed in a shape of a ring is disposed in a space provided between the external flange 316 and internal flange 318, and the eyelet washer 310 is adhered and fixed to the object OBJ, thereby insulating the RFID module 340 by the eyelet washer 310 and protecting the RFID module 340 from external shocks.

The eyelet base 320 is provided being faced with the eyelet washer. The eyelet base 320 includes a rim 325 and a barrel 330. The barrel 330 includes a first barrel piece 332 and second barrel piece 334 to form a cylinder shape. As described above, a plurality of slanted projections 336 are formed on the first and second barrel pieces 332 and 334 in response to the locker 314 including a plurality of projections. The slanted projection 336 formed in a ring shape is formed on the end portion of the first barrel piece 332 and second barrel piece 334 to engage the barrel 330 with the locker 314 in a certain position.

In this case, the first barrel piece 332 and second barrel piece 334 pass through the washer hole 312 and are slightly slanted. A user can control the engagement position between the slanted projection 336 and locker 314. The interval between the eyelet washer 310 and eyelet base 320 can be changed according to the thickness of the object OBJ and the thickness of the RFID module 340 installed inside. Accordingly, the RFID eyelet can apply the optimum interval simultaneously with installation process and be installed regardless of the thickness of the object OBJ in a certain interval range.

The RFID module 340 is formed in a ring shape similar to the eyelet washer 310, which is the same as the first embodiment. The RFID module 340 includes an RFID substrate 342, an antenna 344, and an RFID chip 346. The RFID substrate 342 is a film composed of nonconductive material. The antenna 344 is formed in a pattern shape on the RFID substrate 342 by etching method. The RFID chip 346 is electrically connected to the antenna 344 and formed above the RFID substrate 342.

Since the eyelet washer 310 and eyelet base 320 for protecting the RFID module 340 are composed of nonconductive material, the RFID module 340 and an external reader-writer device RW can perform electromagnetic wave communication without disturbance. Also, the eyelet washer 310 can simply coupled with the eyelet base 320 by coupling between the slanted projection 336 and locker 314, and the coupling interval can be easily controlled. Also, the size of a passage hole 343 can be controlled such that the internal flange 318 of the eyelet washer 310 circumscribes the RFID substrate 342. That is, the shape of the RFID substrate 342 is controlled based on the internal flange 318 or external flange 316, thereby rapidly installing the RFID module 340 to the eyelet washer 310, stably fixing after installing, and preventing the RFID module 340 from being out of the regular position.

### Embodiment 3

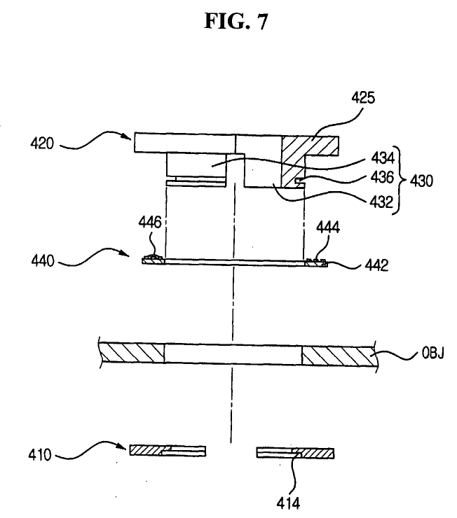

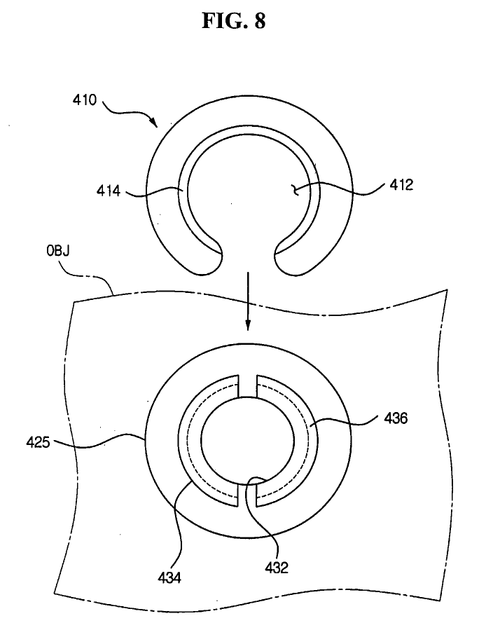

FIG. 7 is an exploded side view of an RFID eyelet according to a third embodiment of the present invention, and FIG. 8 is a bottom view illustrating a state of coupling the RFID eyelet according to the third embodiment.

Referring to FIGS. 7 and 8, the RFID eyelet according to the third embodiment includes an eyelet washer 410, an eyelet base 420, and an RFID module 440. The object OBJ and the RFID module 440 are interposed between the eyelet washer 410 and eyelet base 420 and closely adhered and fixed by interlock between the eyelet washer 410 and eyelet base 420.

Similarly to the first embodiment, the eyelet washer 410 is formed in a circle shape, and a washer hole 412 and locker section 414 are formed in the center of the eyelet washer 410. Only, eyelet washer 410 is partially cut opened, and the washer hole 412 has an opening opened as the section. Also, the locker section 414 is formed along the inner circumference of the washer hole 412 in response to a fixing groove 436 of the eyelet base 420. The locker section 414 is formed at an upper portion of the eyelet washer 410 to closely contact to the object OBJ.

The eyelet base 420 is provided being faced with the eyelet washer 410. The eyelet base 420 includes a rim 425 and a barrel 430. The barrel 430 includes a first barrel piece 432 and second barrel piece 434 to form a cylinder shape. As described above, the fixing groove 436 containing the locker section 414 is formed around the circumference of the barrel 430 in the first and second barrel pieces 432 and 434 in response to the locker section 414. The fixing groove formed in a ring shape is formed on the end portion of the first barrel piece 432 and second barrel piece 434 to be coupled with the locker 414, thereby fixing the eyelet washer 410 and eyelet base 420 to the object OBJ.

Referring to FIG. 8, when the eyelet washer 410 is engaged with the barrel 430 passing through the object OBJ, the opening of the eyelet washer 410 approaches to the side of the barrel 430 and the locker section 414 of the eyelet base 410 is engaged with the fixing groove 436, thereby coupling the eyelet washer 410 with the eyelet base 420. In this case, the eyelet washer 410 enters becomes open centered on the opening, and the first barrel piece 432 and second barrel piece 434 are slightly slanted inside such that the eyelet washer 410 easily enters. Also, the end portion of the eyelet washer 410 may be rounded off, thereby inducing the end portion of the eyelet washer 410 to easily enter.

The RFID module 440 is interposed between the rim 425 of the eyelet base 420 and the object OBJ. The RFID module 440 is also formed in a ring shape similar to the rim 425 and includes an RFID substrate 442, an antenna 444, and an RFID chip 446. The RFID substrate 442 is a sheet composed of nonconductive material, and the antenna 444 is formed in a pattern shape on the RFID substrate 442 by etching or embedding. The RFID chip 446 is electrically connected to the antenna 444 and formed above the RFID substrate 442.

Since the eyelet washer 410 and the eyelet base 420 are composed of nonconductive material, the RFID module and an external reader-writer device RW can perform electromagnetic wave communication without disturbance. Also, the eyelet washer 410 and eyelet base 420 can be simply coupled with each other by interlock between the fixing groove 436 and locker section 414.

Differently from the previous embodiments, an external flange is not formed on the rim 425 of the eyelet base 420 according to the present embodiment. However, according to another embodiment of the present invention, an external flange projected from the outside of the rim can protect an RFID module, and the size of the flange is controlled such that the RFID module is inscribed in the external flange, thereby stably fixing the RFID module.

The eyelet washer 110 and eyelet base 120 can be separated to recycle the RFID tag 140 and a high-priced RFID module can be reused, thereby obtaining economical saving effect. However, it is necessary to prevent forgery or falsification according to goods in which the RFID eyelet 100 is used. In this case, an RFID module is firmly adhered using adhesives, thereby making the separation of the RFID module impossible. Also, a function to damage an RFID chip is added in order to previously prevent abusing the RFID module.

### INDUSTRIAL APPLICABILITY

Accordingly, the RFID eyelet according to the present invention can perform a first function to insulate an RFID module from the outside and simultaneously perform a second function to protect the RFID module from external shocks without disturbing smooth communication between the RFID module and a reader-writer device. Concretely, when conductive material such as metal is used for protecting the RFID module, the communication between the RFID module and the reader-writer device is disturbed. When nonconductive material such as plastic is used, the defect of being easily damaged by external shocks can not be overcome. However, nonconductive material is used and the eyelet structure is applied, thereby obtaining effects of smooth communication between the RFID module and an external reader-writer device and sufficiently protecting the RFID module.

Also, since the eyelet structure is closely adhered and fixed to an object and has a relatively small size, a space for installing an RFID is small and the RFID module can be effectively protected from harsh external environment.

Also, since the eyelet is used in many fields in real life, the application fields and ripple effects is enormously grown. The manufacture and installation processes are simple to be profitable to mass production. In addition, since the technology to manufacture assembly systems such as eyelet coupling devices is already developed, and the systems are widely used, the cost of grafting the eyelet technology into the RFID technology is not high.

Also, the RFID eyelet can be applied to various fields by minimizing the size of a tag.

Also, since the RFID module of the RFID eyelet is relatively high-priced, many economical effects can be obtained when the RFID module is recycled. Accordingly, the eyelet structure that is easy to separate or dismantle is used, thereby simply separating the high-priced RFID module after once using the RFID eyelet to recycle and obtaining economical effects caused by recycling. However, it is necessary to prevent forgery or falsification according to goods in which the RFID eyelet 100 is used. In this case, an RFID module is firmly adhered using adhesives, thereby making the separation of the RFID module impossible. Also, a function to damage an RFID chip is added in order to previously prevent abusing the RFID module.

Also, since the eyelets of various shapes and designs are used, the RFID eyelet can be presented in various shapes and colors to elevate the value of goods.

As described above, while the present invention has been particularly shown and described with reference to exemplary embodiments thereof, it will be understood by those of ordinary skill in the art that various changes in form and details may be made therein without departing from the spirit and scope of the present invention as defined by the following claims.

1. An eyelet for RFID, comprising:
an eyelet washer formed of nonconductive material;
an eyelet base, formed of nonconductive material, including a rim disposed against the eyelet washer with an object therebetween and a barrel formed in a single body with the rim, passing through the object, and fixed to a washer hole formed in the eyelet washer; and
an RFID module interposed between the eyelet washer and the eyelet base with the object.

2. The eyelet of claim 1, wherein the RFID module comprises an RFID substrate including a passage hole in response to the barrel, an antenna formed around the passage hole on the RFID substrate, and an RFID circuit, formed on the RFID substrate, connected to the antenna.

3. The eyelet of claim 1, wherein the RFID module comprises an outer line formed equivalent or smaller than one of the passage hole in response to the barrel, the adjacent eyelet washer, and the rim of the eyelet base.

4. The eyelet of claim 3, wherein an external flange is formed around the outside of one of the eyelet base and eyelet washer adjacent to the RFID module and a space for disposing the RFID module between the object and the eyelet for RFID is formed by the external flange.

5. The eyelet of claim 3, wherein an internal flange is formed around the circumference of the washer hole of the eyelet washer adjacent to the RFID module and a space for disposing the RFID module between the object and the eyelet for RFID is formed by the internal flange.

6. The eyelet of claim 1, wherein at least one slanted projection is formed on the outside of the barrel, a locker is formed adjacent to the washer hole in the eyelet washer in response to the slanted projection, and the eyelet base and the eyelet washer are fixed to the object by the engagement of the slanted projection and the locker.

7. The eyelet of claim 6, wherein the barrel is composed of at least one barrel piece on which the slanted projection is formed and the end portion of the barrel piece is supported by the rim to be elastically engaged with the eyelet washer.

8. The eyelet of claim 1, wherein at least one fixing groove is formed around the outside of the end portion of the barrel, the eyelet washer has an opening such that washer hole is partially open through the opening, a locker section is formed around the inner circumference of the washer hole of the eyelet washer in response to the fixing groove.

9. The eyelet of claim 1, wherein the nonconductive material is synthetic resin.
